(19) United States
(12) Patent Application Publication
(10) Pub. No.: US 2006/0223514 A1
(43) Pub. Date: Oct. 5, 2006

(54) Signal enhancement through diversity

(75) Inventors: Douglas D. Weaver, Plymouth, MN (US); Santosh K. Sonbarse, Eden Prairie, MN (US); William J. Mitchell, Eden Prairie, MN (US); Michael J. Hermel, Waseca, MN (US); Donald R. Bauman, Waseca, MN (US); Jerry Edward Toms, Shakopee, MN (US)

Correspondence Address: FOGG AND ASSOCIATES, LLC, P.O. BOX 581339, MINNEAPOLIS, MN, 55458-1339, US

(73) Assignee: ADC Telecommunications, Inc., Eden Prairie, MN (US)

(21) Appl. No.: 11/094,848

(22) Filed: Mar. 31, 2005

(51) Int. Cl. H04M 3/00

(52) U.S. Cl. 455/418; 455/101

(57) ABSTRACT

Methods and systems for improving signal quality using diversity are provided. Two or more radio antennas are adapted to receive radio signals from wireless devices. One or more servers are adapted to receive two or more data streams, wherein each data stream is a digital representation of radio signals received by one radio antenna of the two or more radio antennas. Each data stream of the two or more data streams is received by a call processing software module through independent reverse link paths.

### CROSS REFERENCES TO RELATED APPLICATIONS

This application is related to the following co-pending U.S. patent applications filed on even date herewith, all of which are hereby incorporated herein by reference:

U.S. patent application Ser. No. ______ (attorney docket number 100.672US01 entitled “DYNAMIC FREQUENCY HOPPING”) and which is referred to here as the '672 Application;

U.S. patent application Ser. No. ______ (attorney docket number 100.673US01 entitled “DYNAMIC DIGITAL UP AND DOWN CONVERTERS”) and which is referred to here as the '673 Application;

U.S. patent application Ser. No. ______ (attorney docket number 100.675US01 entitled “DYNAMIC RECONFIGURATION OF RESOURCES THROUGH PAGE HEADERS”) and which is referred to here as the '675 Application;

U.S. patent application Ser. No. ______ (attorney docket number 100.677US01 entitled “SNMP MANAGEMENT IN A SOFTWARE DEFINED RADIO”) and which is referred to here as the '677 Application;

U.S. patent application Ser. No. ______ (attorney docket number 100.678US01 entitled “TIME STAMP IN THE REVERSE PATH”) and which is referred to here as the '678 Application;

U.S. patent application Ser. No. ______ (attorney docket number 100.679US01 entitled “BUFFERS HANDLING MULTIPLE PROTOCOLS”) and which is referred to here as the '679 Application;

U.S. patent application Ser. No. ______ (attorney docket number 100.680US01 entitled “TIME START IN THE FORWARD PATH”) and which is referred to here as the '680 Application;

U.S. patent application Ser. No. ______ (attorney docket number 100.681US01 entitled “LOSS OF PAGE SYNCHRONIZATION”) and which is referred to here as the '681 Application;

U.S. patent application Ser. No. ______ (attorney docket number 100.684US01, entitled “DYNAMIC REALLOCATION OF BANDWIDTH AND MODULATION PROTOCOLS” and which is referred to here as the '684 Application;

U.S. patent application Ser. No. ______ (attorney docket number 100.685US01 entitled “DYNAMIC READJUSTMENT OF POWER”) and which is referred to here as the '685 Application;

U.S. patent application Ser. No. ______ (attorney docket number 100.686US01 entitled “METHODS AND SYSTEMS FOR HANDLING UNDERFLOW AND OVERFLOW IN A SOFTWARE DEFINED RADIO”) and which is referred to here as the '686 Application; and

U.S. patent application Ser. No. ______ (attorney docket number 100.700US01 entitled “INTEGRATED NETWORK MANAGEMENT OF A SOFTWARE DEFINED RADIO SYSTEM”) and which is referred to here as the '700 Application.

### TECHNICAL FIELD

The following description relates generally to communication systems and in particular to wireless communication systems.

### BACKGROUND

Many changes are taking place in the way wireless communication networks are being deployed. Some of the changes are being driven by the adoption of new mobile communications standards. The introduction of software defined radios to wireless telecommunications has led to the generation of software and hardware solutions to meet the new standards. Current mobile communication standards introduce physical and logical channels and pose new issues in the transport of information within the communication networks.

A software defined radio (SDR) uses software for the modulation and demodulation of radio signals. The use of reprogrammable software allows key radio parameters, such as frequency and modulation protocols to be modified without the need to alter the underlying hardware of the system. Additionally, SDRs allow a single device to support multiple configurations which previously would have required multiple hardware devices. One example of a software defined radio is the Vanu Software Radio produced by Vanu, Inc. (See U.S. Pat. No. 6,654,428).

One problem that continues with current mobile communication systems, including SDRs is that cellular signals are subject to fading and noise interference from other signals or environmental conditions. In order to improve the quality of voice and data signals, cellular systems often utilize two receiving antennas usually separated by a certain distance, both receiving the same transmitted signal from a cellular user.

For the reasons stated above, and for other reasons stated below that will become apparent to those skilled in the art upon reading and understanding the present specification, there is a need in the telecommunications industry for improved methods and systems for processing multiple antenna reception signals for software defined radios.

### SUMMARY

Embodiments of the present invention address the problem of signal quality enhancement, as well as other problems and will be understood by reading and studying the following specification.

In one embodiment, a communications system is provided. The communication system comprises two or more radio antennas adapted to receive radio signals from one or more wireless devices; one or more servers adapted to receive two or more data streams, wherein each data stream is a digital representation of radio signals received by one of the two or more radio antennas; and a call processing software module, wherein each data stream of the two or more data streams is received by the call processing software module through independent reverse link paths.

In another embodiment, a method for improving signal quality is provided. The method comprises receiving radio signals at two or more radio antennas; and communicating two or more data streams representing the radio signals through independent reverse link paths to a call processing software module.

In still another embodiment, a computer-readable medium having computer-executable instructions for performing a method for improving signal quality for a software defined radio is provided. The method comprises receiving two or more data streams of complex RF samples representing radio signals through independent reverse link paths and choosing one data stream of the two or more data streams based on signal quality criteria.

In yet another embodiment, another communication system is provided. The system comprises means for receiving radio signals at two or more locations; means for digitally modulating and demodulating waveforms; and means for communicating two or more data streams representing the radio signals through independent reverse link paths.

### DRAWINGS

The present invention is more easily understood and further advantages and uses thereof more readily apparent, when considered in view of the description of the preferred embodiments and the following figures in which:

FIGS. 1A and 1B are block diagrams of one embodiment of a communications system of the present invention.

FIG. 1C is a block diagram of one embodiment of a reverse logical channel for a communications system of the present invention.

FIG. 1D is a block diagram of one embodiment of a diversity channel for a communications system of the present invention.

In accordance with common practice, the various described features are not drawn to scale but are drawn to emphasize features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention concern portions of a software defined radio system, such as a cellular telecommunications network, that typically comprise cellular antennas, a radio head transmitting and receiving voice and/or data communications over the cellular antennas, and a base station (also commonly called a base transceiver station (BTS), or a server) that communicate voice and data signals between the radio head and a larger communication network (e.g. the public switched telephone network, or the Internet). One or more base stations are connected to a base station controller (BSC) that controls data communication flow in one or more connected base stations.

In some embodiments, communications between a BTS and a remote unit take place through two sets of data. Typically, forward logical channels carry data from the BTS through the radio head to an end user device. Reverse logical channels carry data from end user devices through the radio head to the BTS. Each logical channel is assigned a radio frequency (RF) channel and a modulation protocol, which the communications network uses to wirelessly communicate data with individual cellular devices.

Embodiments of the present invention provide for additional reverse channels that duplicate the reverse logical channels. The set of duplicate reverse logical channels are referred to in the present invention as diversity channels. Embodiments of the present invention provide two or more independent data paths through which digital signals from multiple cellular antennas are independently processed so that a BTS may select the better of the two signals, or otherwise process the signals to improve the quality of data communicated to the larger communication network. The independent data paths may comprise physically separate paths or independent processing of multiplexed signals, as described in this specification below.

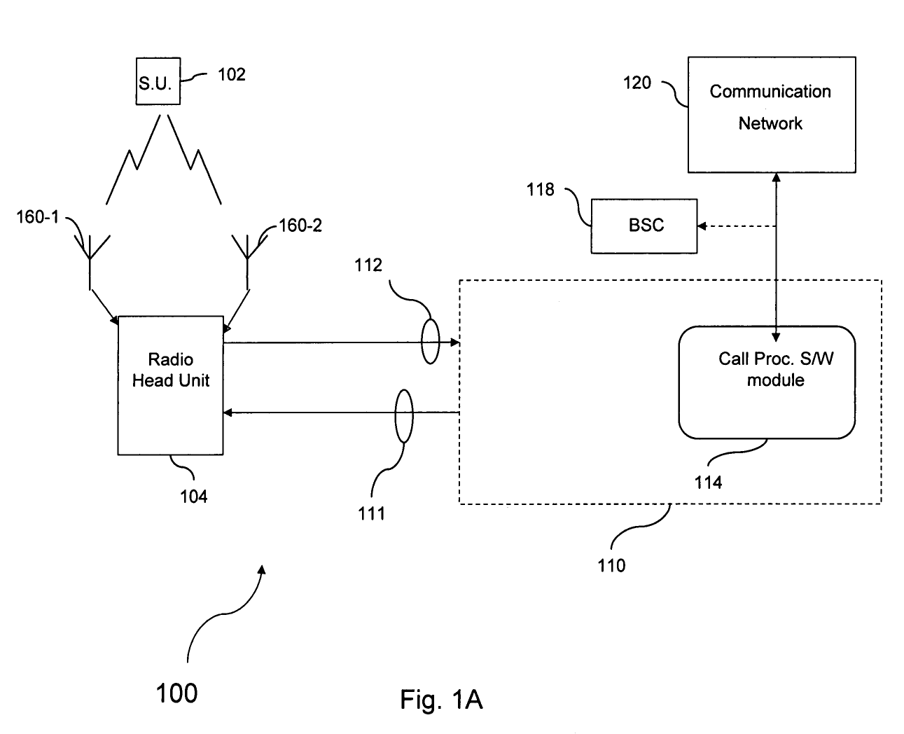

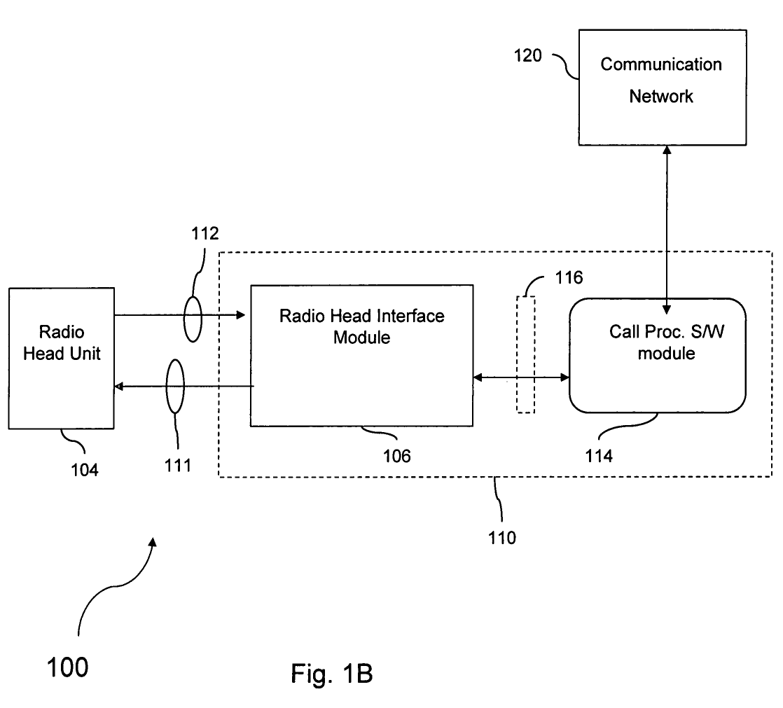

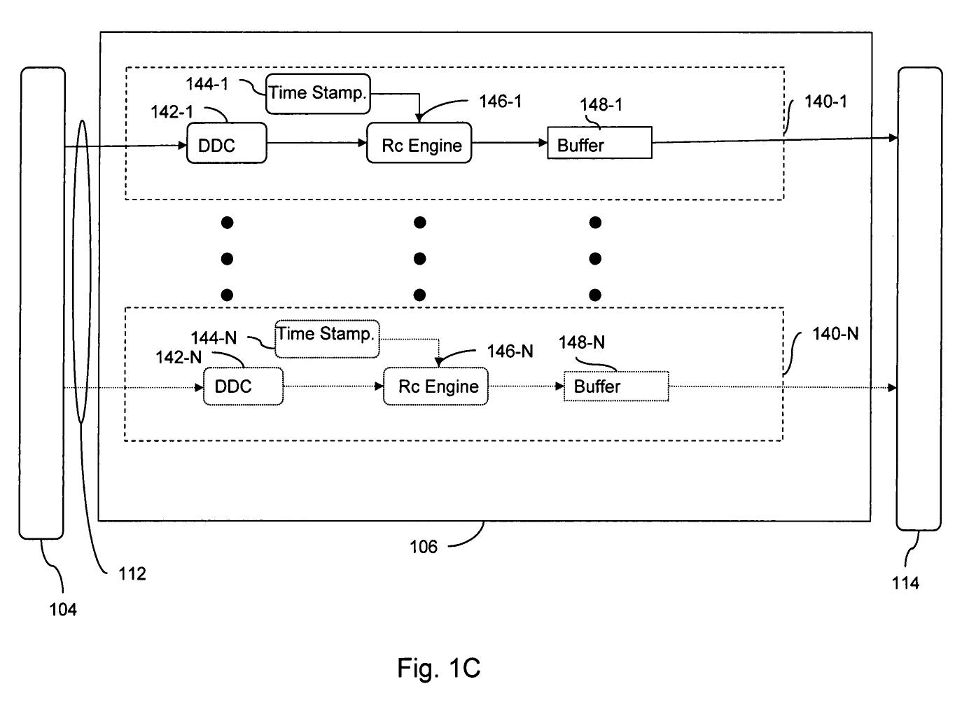

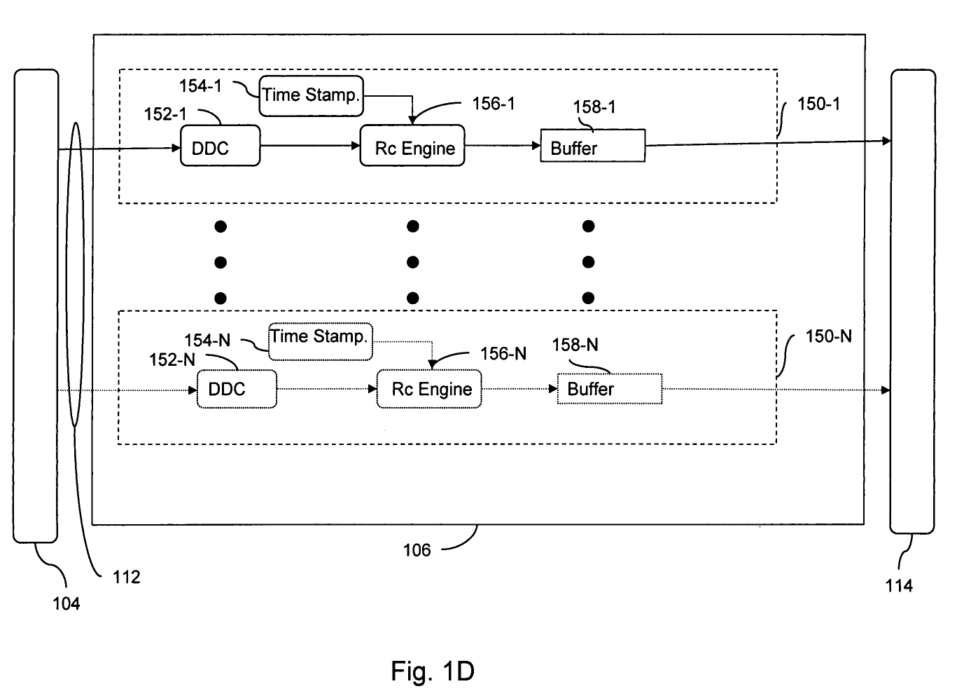

FIGS. 1A, 1B and 1C are block diagrams of one embodiment of a communication system shown generally at 100. Communication system 100 includes one or more subscriber units 102 (or mobile devices 102) within a service area of a radio head unit 104. Radio head unit 104 is coupled to one or more servers 110 (or BTS 110) over one or more transport mediums 111, and 112. BTS 110 is connected to one or more communication networks 120 (e.g. public switched telephone network (PSTN), Internet, a cable network, or the like). In one embodiment, BTS 110 is connected to one or more communication networks through a base station controller (BSC) 118. Cellular antennas 160-1 and 160-2, each adapted for receiving cellular signals from one or more subscriber units 102, are each coupled to radio head unit 104. In one embodiment, network 100 is a bidirectional network and as shown includes equipment for forward links (i.e. transmissions on forward logical channels from communications network 120 to mobile device 102) and reverse links (i.e. transmissions on reverse logical channels from mobile device 102 to communications network 120). BTS 110 includes a call processing software module 114 (or call processing software 114) that interfaces with one or more communication networks 120. Call processing software module 114 also includes programming which implements as SDR with the BTS 110 and radio head unit 104 hardware, digitally performing waveform processing to modulate and demodulate radio signals transmitted and received, respectively, from the cellular antennas 160-1 and 160-2. In one embodiment, call processing software module 114 is a Vanu, Inc., Vanu Software Radio.

Embodiments of the present invention provide independent digital reverse link paths for signals from each cellular antenna 160-1 and 160-2 through BTS 110 to call processing software module 114. In one embodiment, a reverse link path from antenna 160-1 is designated as the primary reverse link path while the reverse link paths from antenna 160-2 are designated as a diversity path. In one embodiment, each reverse link path carries voice and data signals for one or more logical channels. Logical channels carried by the primary reverse link path are simply designated “reverse logical channels” while logical channels carried through diversity paths are designated “diversity channels.”

In one embodiment, transport mediums 111 and 112 comprise one or more high speed digital data transport mediums. In one embodiment, transport medium 112 comprises one optical fiber data path for reverse logical channels and separate optical fiber paths for each set of diversity channels. In one embodiment, transport medium 112 comprises one or more optical fibers utilizing wavelength division multiplexing to transmit reverse logical channels and diversity channels to BTS 110. In another embodiment, transport medium 112 comprises one or more optical fibers utilizing separate digital bit streams for reverse logical channels and diversity channels. In another embodiment, transport medium 112 comprises one optical fiber with reverse logical channels and diversity channels utilizing different time slots of a single digital bit stream. These embodiments are presented as examples of possible high speed data transport mediums as it would be well understood by one in the art upon reading this specification that transmit mediums 111 and 112 are not limited to optical fiber media.

In one embodiment, BTS 110 communicates with radio head unit 104 through a radio head interface module 106 (or radio head interface 106) as illustrated in FIG. 1B. Radio head interface 106 establishes high speed digital communication paths for base band data stream logical channels (i.e. reverse logical channels and diversity channels) and all communication between BTS 110 and radio head unit 104 goes through radio head interface 106.

In one embodiment, radio head interface module 106 is coupled to BTS 110 through an interface device 116. In one embodiment, interface device 116 is one of, but not limited to a PCI-X interface, an ATCA interface, a PCI Express interface, a Gigabit Ethernet interface, a SCSI interface, a Rocket I/O interface, a UDP/IP link interface, a TCP/IP link interface, a Serial ATA interface, a Card bus for PCMIA card interface, a high speed serial interface, a high speed parallel interface, or the like.

FIG. 1C illustrates one embodiment of a reverse logical channel 140-1 data path of the present invention. In one embodiment, a radio head interface reverse logical channel 140-1 comprises a receive buffer 148-1, a receive engine 146-1, a Digital Down Converter (DDC) 142-1 and a time stamper 144-1. In operation, antenna 160-1 receives a voice/data signal from a subscriber unit 102, which is received by radio head unit 104. Radio head unit 104 transmits the voice/data signal via transmit medium 112 to radio head interface module 106. In one embodiment, the voice/data signal carries complex RF samples. DDC 142-1 receives the voice/data signal from transmit medium 112. In one embodiment, receive engine 146-1 receives complex RF data samples from DDC 142-1 and sends the complex RF data samples to receive buffer 148-1. In one embodiment, as receive buffer 148-1 receives the complex RF data samples, a page of complex RF data samples is formed in receive buffer 148-1. When completed, the page of complex RF data samples is transmitted by radio head interface module 106 to call processing software module 114. In some embodiments receive engine 146-1 inserts a page header into receive buffer 148-1 with the complex RF data samples and the page is transmitted by radio head interface module 106 to call processing software module 114. In other embodiments, radio head interface 106 comprises a plurality of N reverse logical channels 140-1 through 140-N each having receive buffers 148-1 through 148-N, receive engines 146-1 through 146-N, DDCs 142-1 through 142-N and time stampers 144-1 through 144-N, each logical channel processing voice/data signals received by antenna 160-1. Additional details pertaining to time stampers are provided in the '678 Application herein incorporated by reference. Additional details pertaining to digital downconverters, time stampers, and page headers are provided respectively in the '673, '678, and '675 Applications herein incorporated by reference.

FIG. 1D illustrates one embodiment of a diversity channel 150-1 data path of the present invention. In one embodiment, radio head interface diversity channel 150-1 comprises a receive buffer 158-1, a receive engine 156-1, a DDC 152-1 and a time stamper 154-1. In operation, radio head unit 104 receives a voice/data signal from a subscriber unit 102 through an antenna other than antenna 160-1 (e.g. antenna 160-2). Radio head unit 104 transmits the voice/data signal via transmit medium 112 to radio head interface module 106. In one embodiment, the voice/data signal carries complex RF samples. DDC 152-1 receives the voice/data signal from transmit medium 112. In one embodiment, receive engine 156-1 receives complex RF data samples from DDC 152-1 and sends the complex RF data samples to receive buffer 158-1. In one embodiment, as receive buffer 158-1 receives the complex RF data samples, a page of complex RF data samples is formed in receive buffer 158-1. When completed, the page of complex RF data samples is transmitted by radio head interface module 106 to call processing software module 114. In some embodiments, receive engine 156-1 inserts a page header into receive buffer 158-1 with the complex RF data samples and the page is transmitted by radio head interface module 106 to call processing software module 114. In other embodiments, radio head interface 106 comprises a plurality of N diversity channels 150-1 through 150-N each having receive buffers 158-1 through 158-N, receive engines 156-1 through 156-N, DDCs 152-1 through 152-N and time stampers 154-1 through 154-N, each logical channel processing voice/data signals received by antenna 160-2.

As would be readily evident to one skilled in the art upon reading this specification, the present invention is not limited to communications systems with only two receiving antenna, but additional sets of diversity channels, such as diversity channel 150-1 to 150-N, can be added to accommodate signals from additional antennas.

With the present invention, a radio such as a software defined radio, cognitive radio or the like, can choose among signals from a plurality of receiving antennas to choose the best signal available. In one embodiment, call processing software module 114 decides to keep one signal over the other based on, but not limited to: signal strength (e.g. based on a receive signal strength indicator), signal bit error rate, or modulation quality (e.g. error vector magnitude). Call processing software module 114 may switch between associated receive and diversity channels in real time, or may permanently or temporarily disable a receive or diversity logical channel. In one embodiment, because of a failed or degraded component in one receive path, call processing software module 114 disables a receive or diversity logical channel until repairs are made. In one embodiment, antennas 160-1 and 160-2 each have antenna reception patterns slightly different from each other, or one may intermittently pick up interference that the other antenna is not susceptible to. In the latter case, in one embodiment, call processing software module 114 initially chooses to use the signal from one antenna, and then dynamically switches antennas as the relative reception quality of the signals from the antennas changes.

In one embodiment, the signal gain of associated receive logical channels and diversity channels are independently adjusted as provided by the '685 Application herein incorporated by reference. In one embodiment, radio head interface 106 is dynamically reconfigured to adjust one or more of reverse logical channels 140-1 to 140-N signal gain for reverse link data samples. In one embodiment, radio head interface 106 is dynamically reconfigured to adjust one or more of diversity channels 150-1 to 150-N signal gain for reverse link data samples. Increasing or decreasing the signal gain of a reverse logical channel or a diversity channel may be desired in situations where changes in network hardware (e.g. replacement of a cellular antenna on radio head 104) alter the overall signal gain of a logical channel. In other embodiments, dynamic adjustment of signal gains for associated reverse and diversity logical channels allows the two reverse link data stream signal power levels to be equalized to compensate for diverse network hardware such as, but not limited to, antennas with different gains. In other embodiments, dynamic adjustment of signal gains for reverse or diversity logical channels provides additional flexibility by providing call processing software 114 the options of switching antennas, adjusting signal gain, or both, in order to improve the voice/data signal quality. Additional details regarding dynamic power adjustment for reverse logical channels and diversity channels are discussed in the '685 Application herein incorporated by reference.

Several ways are available to implement the radio head interface module and server elements of the current invention. These include, but are not limited to, digital computer systems, programmable controllers, or field programmable gate arrays. Therefore other embodiments of the present invention are the program instructions resident on computer readable media which when implemented by such controllers, enable the controllers to implement embodiments of the present invention. Computer readable media include any form of computer memory, including but not limited to magnetic disk or tape, CD-ROMs, DVD-ROMs, or any optical data storage system, flash ROM, non-volatile ROM, or RAM.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A communications system, the system comprising:
two or more radio antennas adapted to receive radio signals from one or more wireless devices;
one or more servers adapted to receive two or more data streams, wherein each data stream is a digital representation of radio signals received by one of the two or more radio antennas; and
a call processing software module, wherein each data stream of the two or more data streams is received by the call processing software module through independent reverse link paths.

2. The system of claim 1, further comprising:
one or more radio head units, wherein the one or more radio head units are adapted to receive the radio signals received by the two or more radio antennas.

3. The system of claim 2, further comprising:
one or more high speed transport mediums, wherein the one or more radio head units communicate the two or more data streams to the one or more servers through the one or more high speed transport mediums.

4. The system of claim 2, further comprising:
one or more radio head interface modules adapted to communicate with the call processing software module, wherein the one or more radio head interface modules are further adapted to receive the two or more data streams.

5. The system of claim 4, further comprising:
one or more interface devices, wherein the one or more radio head interface modules communicate with the call processing software module over the one or more interface devices.

6. The system of claim 5, wherein the one or more interface devices includes at least one of a PCI-X interface, an ATCA interface, a PCI Express interface, a Gigabit Ethernet interface, a SCSI interface, a Rocket I/O interface, a UDP/IP link interface, a TCP/IP link interface, a Serial ATA interface, a Card bus for PCMIA card interface, a high speed serial interface and a high speed parallel interface.

7. The system of claim 4, wherein the radio head interface module further comprises:
one or more reverse logical channels, each reverse logical channel including:
a receive buffer;
a receive engine; and
a digital downconverter adapted to receive a data stream representing radio signals received by a first radio antenna of the two or more radio antennas,
the receive engine adapted to transfer a data stream from the digital downconverter to the receive buffer, the receive buffer adapted to store the data stream as a page of data samples, the receive buffer further adapted to output the page of data samples to the call processing software; and
one or more diversity channels, each diversity channel including:
a receive buffer;
a receive engine; and
a digital downconverter adapted to receive a data stream representing radio signals received by a second radio antenna of the two or more radio antennas,
the receive engine adapted to transfer a data stream from the digital downconverter to the receive buffer, the receive buffer adapted to store the data stream as a page of data samples, the receive buffer further adapted to output the page of data samples to the call processing software.

8. The system of claim 7, wherein the radio head interface module comprises one associated diversity channel for each reverse logical channel.

9. The system of claim 7, wherein the call processing software module is adapted to select between processing a page of data samples from a reverse logical channel or processing a page of data samples from an associated diversity channel.

10. The system of claim 9, wherein the selection is based on one or more of signal strength, signal bit error rate, and modulation quality.

11. The system of claim 9, wherein the call processing software module is adapted to adjust signal gain of data samples of the page of data samples from reverse logical channel and adjust signal gain of data samples of the page of data samples from an associated diversity channel, independently.

12. The system of claim 7, wherein the call processing software module is adapted to disable one or more reverse logical channels or one or more diversity channels.

13. A radio head interface module for a software defined radio, the module comprising:
one or more reverse logical channels, each reverse logical channel including:
a receive buffer;
a receive engine; and
a digital downconverter adapted to receive a data stream representing radio signals received by a first radio antenna,
the receive engine adapted to transfer a data stream from the digital downconverter to the receive buffer, the receive buffer adapted to store the data stream as a page of data samples, the receive buffer further adapted to output the page of data samples; and
one or more diversity channels, each diversity channel including:
a receive buffer;
a receive engine; and
a digital downconverter adapted to receive a data stream representing radio signals received by a second radio antenna,
the receive engine adapted to transfer a data stream from the digital downconverter to the receive buffer, the receive buffer adapted to store the data stream as a page of data samples, the receive buffer further adapted to output the page of data samples.

14. A method for improving signal quality, the method comprising:
receiving radio signals at two or more radio antennas; and
communicating two or more data streams representing the radio signals through independent reverse link paths to a call processing software module.

15. The method of claim 14 further comprising:
choosing one data stream of the two or more data streams.

16. The method of claim 14 further comprising:
receiving the two or more data streams at a call processing software module; and
choosing one data stream of the two or more data streams based on signal quality criteria.

17. The method of claim 16, wherein choosing one data stream of the two or more data streams based on signal quality criteria is based on one or more of signal strength, signal bit error rate and modulation quality.

18. The method of claim 14 further comprising:
independently adjusting the signal gain of the two or more data streams.

19. The method of claim 14 further comprising:
equalizing the signal gain of two streams of complex RF samples between the two or more data streams.

20. A computer-readable medium having computer-executable instructions for performing a method for improving signal quality for a software defined radio, the method comprising:
receiving two or more data streams of complex RF samples representing radio signals through independent reverse link paths; and
choosing one data stream of the two or more data streams based on signal quality criteria.

21. The method of claim 20, wherein choosing one data stream of the two or more data streams based on signal quality criteria is based on one or more of signal strength, signal bit error rate and modulation quality.

22. The method of claim 20 further comprising:
independently adjusting the signal gain of the two or more data streams.

23. The method of claim 20 further comprising:
equalizing the signal gain of two streams of complex RF samples between the two or more data streams.

24. A communication system, the system comprising:
means for receiving radio signals at two or more locations;
means for digitally modulating and demodulating waveforms; and
means for communicating two or more data streams representing the radio signals through independent reverse link paths.

25. The system of claim 24 further comprising:
means for choosing one data stream of the two or more data streams based on signal quality criteria.

26. The system of claim 25, wherein choosing one data stream of the two or more data streams based on signal quality criteria is based on one or more of signal strength, signal bit error rate and modulation quality.

27. The system of claim 24 further comprising:
means for independently adjusting the signal gain of the two or more data streams.

28. The system of claim 24 further comprising:
means for equalizing the signal gain of two streams of complex RF samples between the two or more data streams.
